(19) United States
(12) Patent Application Publication
(10) Pub. No.: US 2026/0370110 A1
(43) Pub. Date: Nov. 19, 2026

(54) Actuator

(71) Applicant: NIDEC INSTRUMENTS CORPORATION, Nagano (JP)

(72) Inventors: Shinji HATANO, Nagano (JP); Masaaki ANDO, Nagano (JP)

(21) Appl. No.: 19/142,634

(22) PCT Filed: Dec. 18, 2023
(86) PCT No.: PCT/JP2023/045253

§ 371 Date: Jun. 24, 2025

(30) Foreign Application Priority Data
Dec. 28, 2022 (JP) 2022-211132

(51) Int. Cl. H02K 33/18

(52) U.S. Cl. CPC H02K 33/18

(57) ABSTRACT

An actuator includes a controller controlling a magnetic driver vibrating a movable body relative to a support body. A maximum amplitude of the movable body not colliding with the support body is an upper amplitude. Acceleration or amplitude of the movable body becomes maximal when a voltage of the driver is constant at a peak frequency. In a band including the peak frequency, the acceleration becomes a target acceleration and the amplitude exceeds the upper amplitude at the peak frequency at a first voltage. When the voltage is set at the first voltage, if the amplitude becomes the upper amplitude or more in an intermediate frequency band, the controller sets the voltage as the first voltage when driving in low and high frequency bands and, when driving in the intermediate frequency band, the voltage is set lower than the first voltage and the amplitude becomes less than the upper amplitude.

### RELATED APPLICATIONS

The present application is National stage of application No. PCT/JP2023/045253, filed on Dec. 18, 2023, and claims priority based on Japanese Patent Application No. 2022-211132, filed Dec. 28, 2022.

### TECHNICAL FIELD

The present invention relates to an actuator which vibrates a movable body.

### BACKGROUND ART

In Patent Literature 1, an actuator is described which includes a support body and a movable body, a connection body which connects the movable body with the support body, and a magnetic drive circuit which relatively moves the movable body with respect to the support body. The magnetic drive circuit includes a magnet which is mounted on one of the movable body and the support body and a coil which is mounted on the other of the movable body and the support body. The magnet faces the coil in a direction perpendicular to a vibration direction. The connection body is a viscoelastic body such as silicone gel.

The actuator described in Patent Literature 1 can be, for example, incorporated in an operating member or an operation panel of a game machine and the like and can be used as a tactile device which provides a tactile sensation to a user by vibration of the movable body. In this case, the user bodily senses vibration of strength corresponding to weight and acceleration of the movable body. Conventionally, in this type of an actuator, a frequency of a drive current supplied to a coil is set to a frequency near the resonance frequency and thereby, large acceleration is attained.

### CITATION LIST

### Patent Literature

[PTL 1] Japanese Patent Laid-Open No. 2019-013094.

### SUMMARY OF THE INVENTION

### Problems to be Solved by the Invention

When an actuator is used as a tactile device, in order to meet various needs for a tactile sensation which is bodily sensed by a user, there is a request to attain large acceleration in a wide frequency band without being limited near the resonance frequency. The present inventors have focused on the fact that characteristics (spring element and viscous element) of a viscoelastic body are varied by changing a type of the viscoelastic body and have attempted to increase acceleration in a wide frequency band by increasing the viscous element. However, in this case, the maximum amplitude becomes too large and the movable body collides with the support body.

In view of the problem described above, an objective of the present invention is to provide an actuator which is capable of attaining large acceleration in a wide frequency band and avoiding a collision between the movable body and the support body.

### Means to Solve the Problems

To solve the above-mentioned problem, an embodiment of the present invention provides an actuator including a support body and a movable body, a connection body which is connected with the movable body and the support body, a magnetic drive circuit which vibrates the movable body with respect to the support body, and a control part which controls a drive current supplied to the magnetic drive circuit. The connection body is a viscoelastic body, the maximum amplitude of the movable body which does not collide with the support body is defined as an upper limit amplitude, and a frequency, at which acceleration or amplitude of the movable body becomes the maximum in a case that voltage of the drive current is kept in a constant value, is defined as a peak frequency. In a target frequency band including the peak frequency, a voltage at which acceleration of the movable body becomes a target acceleration determined in advance or more, and the voltage at which the amplitude of the movable body exceeds the upper limit amplitude at the peak frequency is defined as a first voltage. When the voltage of the drive current is set at the first voltage, in a case that a frequency band where the amplitude of the movable body becomes the upper limit amplitude or more is an intermediate frequency band which is from a first frequency lower than the peak frequency to a second frequency higher than the peak frequency, the control part sets the voltage of the drive current to be the first voltage when the control part drives in a low frequency band which is lower than the first frequency and in a high frequency band which is higher than the second frequency and, when the control part drives in the intermediate frequency band, the voltage of the drive current is set to be lower than the first voltage and the amplitude of the movable body becomes not more than the upper limit amplitude.

According to the present embodiment, in addition to frequencies near the peak frequency, the acceleration of the movable body can be increased in a further wide range of frequencies. In other words, a voltage at which a target acceleration is obtained in a target frequency band is set as a first voltage and, unless the amplitude of the movable body exceeds the upper limit amplitude, an electric current at the first voltage is supplied to attain large acceleration. On the other hand, in a frequency band in which the amplitude of the movable body exceeds the upper limit amplitude when driven at the first voltage, a voltage of the drive current is set to be lower than the first voltage to avoid a collision between the movable body and the support body. As a result, according to a request, an actuator can be provided in which the target acceleration can be obtained in the target frequency band and a collision between the movable body and the support body can be avoided.

A conventional actuator is designed so that large acceleration can be obtained by driving a movable body at a frequency near a peak frequency. However, the present inventors have focused on the fact that, when a viscoelastic body is used whose viscous element is increased by adjusting characteristics of the viscoelastic body which is used as a connection body, acceleration can be increased in a wide frequency band. Further, the present inventors have reached a technical idea that, when amplitude of the movable body is prevented from becoming too large by reducing voltage near the peak frequency to avoid a collision with the support body, large acceleration can be obtained in a wide frequency band.

In the present embodiment, it is preferable that, when the control part drives at frequencies in the intermediate frequency band, the control part sets the voltage of the drive current to a voltage at which the amplitude of the movable body matches the upper limit amplitude. According to this structure, acceleration of the movable body can be increased to the maximum. Therefore, vibration that a user senses bodily can be increased.

In the present embodiment, as the peak frequency, an acceleration peak frequency may be used at which the acceleration of the movable body becomes maximum when the voltage of the drive current is set at a constant value.

In the present embodiment, the target frequency band may be 50 Hz or more and 100 Hz or less. As described above, when voltage control described in the present embodiment is performed, target acceleration can be obtained in a wide range as well as frequencies near the peak frequency.

In the present embodiment, it is preferable that, when the control part drives at a frequency in a range from the first frequency to the peak frequency, the voltage of the drive current is decreased as the frequency becomes higher and, when the control part drives at the peak frequency, the voltage of the drive current is set at a voltage at which the amplitude of the movable body matches the upper limit amplitude and, when the control part drives at a frequency in a range from the peak frequency to the second frequency, the voltage of the drive current is increased as the frequency becomes higher. As described above, when a voltage pattern in which the voltage becomes lowest at the peak frequency is used, the acceleration of the movable body is capable of exceeding a target value in a wide range.

In the present embodiment, it is preferable that the magnetic drive circuit includes a coil and a magnet facing the coil in a first direction and vibrates the movable body in a second direction intersecting the first direction with respect to the support body, the viscoelastic body is disposed in a portion where the support body and the movable body face each other in the first direction with the first direction as a thickness direction and, when the movable body is moved in the second direction with respect to the support body, the viscoelastic body is deformed in a shear direction. According this structure, the acceleration of the movable body can be increased in a wide frequency band by adjusting characteristics of the viscoelastic body. Therefore, the amplitude of the movable body is prevented from becoming too large by adjusting the voltage of the drive current and a collision between the movable body and the support body can be avoided.

In the present embodiment, silicone gel can be used as the viscoelastic body.

### Effects of the Invention

According to the present embodiment, in addition to frequencies near the peak frequency, the acceleration of the movable body can be increased in a further wide range of frequencies. In other words, a voltage at which a target acceleration is obtained in a target frequency band is set as a first voltage and, unless the amplitude of the movable body exceeds the upper limit amplitude, an electric current at the first voltage is supplied to attain large acceleration. On the other hand, in a frequency band in which the amplitude of the movable body exceeds the upper limit amplitude when driven at the first voltage, a voltage of the drive current is set to be lower than the first voltage to avoid a collision between the movable body and the support body. As a result, according to a request, an actuator can be provided in which the target acceleration can be obtained in the target frequency band and a collision between the movable body and the support body can be avoided.

### BRIEF DESCRIPTION OF THE DRAWINGS

FIG. 1 An outside appearance perspective view showing an actuator in accordance with an embodiment of the present invention.

FIG. 2 The “X-Z” cross-sectional view showing the actuator in FIG. 1.

FIG. 3 The “Y-Z” cross-sectional view showing the actuator in FIG. 1.

FIG. 4 An exploded perspective view showing the actuator in FIG. 1.

FIGS. 5A to 5C Explanatory views showing voltage characteristics, amplitude characteristics and acceleration characteristics of the actuator.

### DESCRIPTION OF EMBODIMENTS

An embodiment of an actuator 1 in accordance with the present invention will be described below with reference to the accompanying drawings. In the following descriptions, three directions intersecting each other are referred to as a first direction “Z”, second direction “X” and third direction “Y”. Further, “X1” refers to one side in the second direction “X”, “X2” refers to the other side in the second direction “X”, “Y1” refers to one side in the third direction “Y”, “Y2” refers to the other side in the third direction “Y”, “Z1” refers to one side in the first direction “Z”, and “Z2” refers to the other side in the first direction “Z”. In this embodiment, the first direction “Z”, second direction “X” and third direction “Y” are directions perpendicular to each other. The second direction “X” is a vibration direction of a movable body 3.

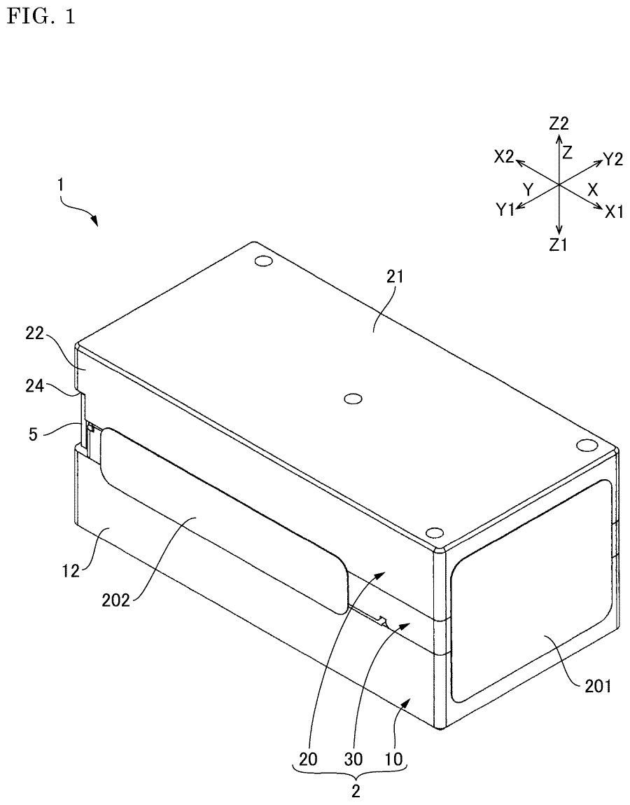

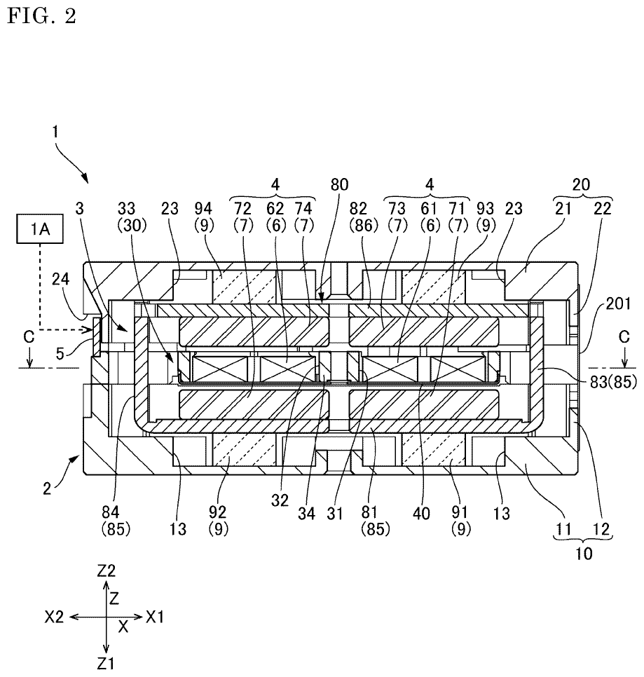

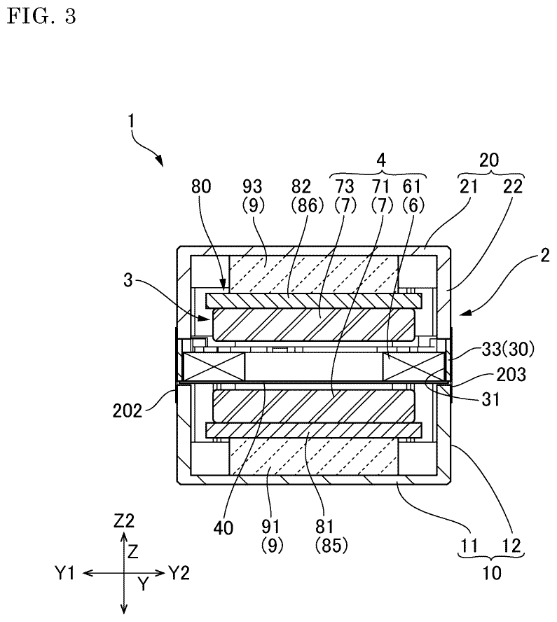

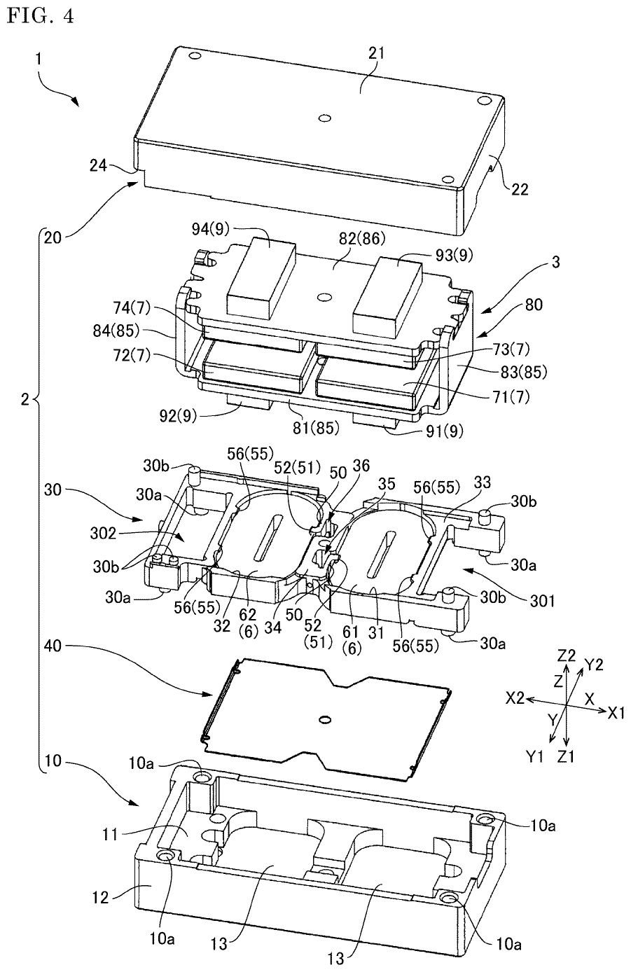

FIG. 1 is a perspective view showing an actuator 1 in accordance with an embodiment of the present invention. FIG. 2 is the “X-Z” cross-sectional view showing the actuator 1 in FIG. 1. FIG. 3 is the “Y-Z” cross-sectional view showing the actuator 1 in FIG. 1. FIG. 4 is an exploded perspective view showing the actuator 1 in FIG. 1.

As shown in FIG. 1, the actuator 1 is, as a whole, formed in a rectangular parallelepiped shape whose dimension in the second direction “X” is larger than a dimension in the third direction “Y” and a dimension in the first direction “Z”. As shown in FIGS. 2, 3 and 4, the actuator 1 includes a support body 2, a movable body 3, a magnetic drive circuit 4 and a wiring board 5. The magnetic drive circuit 4 includes coils 6 and magnets 7 which face each other in the first direction “Z” and vibrates the movable body 3 in the second direction “X”. The coils 6 are connected with the wiring board 5 which is fixed to an outer peripheral face of the support body 2, and an electric current flows to the coils 6 through the wiring board 5.

The actuator 1 includes connection bodies 9 which are connected with the support body 2 and the movable body 3. The movable body 3 is supported by the support body 2 through the connection bodies 9. As described below, the actuator 1 uses a gel member (viscoelastic body) as the connection body 9.

The actuator 1 notifies information to a user through a body of a person utilizing the actuator 1, an apparatus and the like to which the actuator 1 is attached by vibrating the movable body 3 in the second direction “X”. The actuator 1 can be utilized, for example, by incorporating into an operating member of a game machine, an operation panel, a steering wheel of an automobile, a chair or the like, and the actuator 1 can be used as a tactile device which provides a tactile sensation to a user by vibration of the movable body 3 in the second direction “X”.

The actuator 1 includes a control part 1A (see FIG. 2) which controls a drive current supplied to the coils 6 of the magnetic drive circuit 4. The control part 1A supplies a drive current to the coils 6 through the wiring board 5. When the actuator 1 is to be used as a tactile device, an alternating current is supplied to the coils 6 as a drive current. The control part 1A controls a frequency and voltage of the alternating current and thereby, vibration which is bodily sensed by a user of the actuator is controlled. For example, a combination of a frequency and voltage of the alternating current is controlled and thereby, magnitude of acceleration of the movable body 3 is controlled and strength of vibration that a user senses bodily is controlled. In this case, a variation pattern of the alternating current may be controlled. For example, when acceleration that the movable body 3 is moved to one side “X1” in the second direction “X” and acceleration that the movable body 3 is moved to the other side “X2” in the second direction are made to be different from each other, a user is capable of bodily sensing vibration having directionality in the second direction “X”.

The support body 2 includes a first case member 10, a coil holder 30 and a second case member 20 which are overlapped in this order from one side “Z1” to the other side “Z2” in the first direction “Z”. The movable body 3 and the magnetic drive circuit 4 are disposed between the first case member 10 and the second case member 20. In this embodiment, each of the first case member 10, the coil holder 30 and the second case member 20 is made of resin.

As shown in FIG. 4, the coil holder 30 is provided with a protruded part 30a protruded to the first case member 10 side and a protruded part 30b protruded to the second case member 20 side at each of four corner parts. When the support body 2 is assembled, the protruded part 30a of the coil holder 30 is fitted to a hole 10a of the first case member 10, and the protruded part 30b of the coil holder 30 is fitted to a hole (not shown) of the second case member 20. Therefore, the first case member 10, the coil holder 30 and the second case member 20 are connected with each other in a positioned state. The first case member 10, the coil holder 30 and the second case member 20 are, for example, coupled to each other by an adhesive. Alternatively, the actuator 1 may be structured so that the first case member 10, the coil holder 30 and the second case member 20 are held on an inner side of a cover in a tube shape not shown.

The first case member 10 is provided with a first end plate part 11 which is formed with two recessed parts 13 arranged side by side in the second direction “X”, and a first side plate part 12 which is extended to the Z2-direction from an outer circumferential end of the first end plate part 11. The second case member 20 is provided with a second end plate part 21 which is formed with two recessed parts 23 arranged side by side in the second direction “X”, and a second side plate part 22 which is extended to the Z1-direction from an outer circumferential end of the second end plate part 21. The hole 10a to which the protruded part 30a of the coil holder 30 is fitted is opened to a tip end face of each of four corner parts of the first side plate part 12, and the hole (not shown) to which the protruded part 30b of the coil holder 30 is fitted is opened to a tip end face of each of four corner parts of the second side plate part 22.

The wiring board 5 is fixed to a side face in the X2-direction of the coil holder 30. A side face in the X2-direction of the second case member 20 is formed with a recessed part 24 in which an upper end portion of the wiring board 5 protruded to the Z2-direction from the coil holder 30 is disposed. A coil wire (not shown) drawn from the coil 6 is routed along a surface in the Z2-direction of the coil holder 30 and is connected with the wiring board 5.

The coil holder 30 is provided with a first coil arrangement hole 31 and a second coil arrangement hole 32 side by side in the second direction “X”. The first coil arrangement hole 31 is disposed in the X1-direction, and the second coil arrangement hole 32 is disposed in the X2-direction with respect to the first coil arrangement hole 31. The coil holder 30 is provided with a plate part 33 parallel to the “X”-“Y” face, and the first coil arrangement hole 31 and the second coil arrangement hole 32 penetrate through the plate part 33 in the first direction “Z”. A partition part 34 extending in the third direction “Y” is provided between the first coil arrangement hole 31 and the second coil arrangement hole 32. The partition part 34 is located at a substantially center in the second direction “X” of the coil holder 30.

The coil holder 30 is formed with a cut-out part 301 in the X1-direction with respect to the first coil arrangement hole 31, and an opening part 302 is formed in the X2-direction with respect to the second coil arrangement hole 32. The cut-out part 301 and the opening part 302 penetrate through the plate part 33 in the first direction “Z”. Recessed parts 303 and 304 which are recessed to the Y2-direction are provided on a side face in the Y1-direction of the plate part 33. The recessed part 303 is provided at a substantially center in the second direction “X” of the plate part 33, and the recessed part 304 is provided at a position near an end part in the X2-direction of the plate part 33. A recessed part 305 which is recessed to the Y1-direction is provided at a substantially center in the second direction “X” on a side face in the Y2-direction of the plate part 33. The recessed parts 303, 304 and 305 are utilized as wiring spaces when a coil wire (not shown) is drawn out from the coil 6 and is routed to the wiring board 5.

As shown in FIG. 1, an outer peripheral face in the X1-direction of the actuator 1 is stuck with a sealing member 201 which closes the cut-out part 301 of the coil holder 30. In a manufacturing process of the actuator 1, when its inside is to be inspected, inspection light is irradiated through the cut-out part 301. Further, an outer peripheral face in the Y1-direction of the actuator 1 is stuck with a sealing member 202 which closes the recessed parts 303 and 304, and an outer peripheral face in the Y2-direction of the actuator 1 is stuck with a sealing member 203 which closes the recessed part 305.

The support body 2 includes a plate 40 made of metal which is overlapped with the plate part 33 of the coil holder 30 and the coils 6 from the Z1-direction side. The plate 40 is overlapped with the first coil arrangement hole 31 and the second coil arrangement hole 32, but does not overlap with the cut-out part 301 and the opening part 302. When the coils 6 are to be fixed to the coil holder 30, the plate 40 and the coil holder 30 are laminated, and the coils 6 are disposed and fixed to the first coil arrangement hole 31 and the second coil arrangement hole 32 where an adhesive is applied.

As shown in FIG. 4, the coil holder 30 is provided with a spring part 50 which presses an outer peripheral face of the coil 6 for positioning at two positions. The spring part 50 is a resin spring which is integrally formed with the coil holder 30. The spring part 50 is provided at one position on an inner peripheral face in the X2-direction of the first coil arrangement hole 31 and an inner peripheral face in the X1-direction of the second coil arrangement hole 32.

In the coil holder 30, an inner peripheral face in the X1-direction of the first coil arrangement hole 31 and an inner peripheral face in the X2-direction of the second coil arrangement hole 32 are respectively provided with a receiving part 55 at two positions separated from each other in the third direction “Y”. A first coil 61 is pushed to the X1-direction by the spring part 50 and is pressed against the receiving parts 55 in the first coil arrangement hole 31. A second coil 62 is pushed to the X2-direction by the spring part 50 and is pressed against the receiving parts 55 in the second coil arrangement hole 32. Therefore, in each of the first coil 61 and the second coil 62, two receiving parts 55 and one spring part 50 are in contact with a portion of an effective side 601 and thus, each of the first coil 61 and the second coil 62 is supported at three points.

The spring part 50 is disposed on a side face in the X1-direction of the partition part 34, which is disposed at a center in the second direction “X” of the coil holder 30, and is disposed on a side face in the X2-direction of the partition part 34. A side face in the X1-direction of the partition part 34 is provided with a recessed part 35 which is recessed to the X2-direction. The spring part 50 is extended from an opening edge in the Y1-direction of the recessed part 35 toward its opening edge in the Y2-direction. A side face in the X2-direction of the partition part 34 is provided with a recessed part 36 which is recessed to the X1-direction. The spring part 50 is extended from an opening edge in the Y2-direction of the recessed part 36 toward its opening edge in the Y1-direction. Therefore, the spring part 50 is capable of being elastically deformed in the second direction “X”.

A tip end of each of the spring parts 50 is provided with a protruded part 51 which is protruded to a side where the coil 6 is located. A tip end of the protruded part 51 is protruded to an inner peripheral side with respect to an inner peripheral face of each of the coil arrangement holes. Therefore, the spring part 50 pushes the coil 6 by the tip end of the protruded part 51. Further, each of the spring parts 50 is provided with a locking part 52 which is protruded from an end part in the Z2-direction of the protruded part 51. The locking part 52 locks an outer circumferential edge in the X2-direction of the first coil 61 from the Z2-direction. Similarly, a locking part 56 protruded from an end part in the Z2-direction of the receiving part 55 locks an outer circumferential edge in the X1-direction of the first coil 61 from the Z2-direction. As a result, the first coil 61 is held so as not to come out from the first coil arrangement hole 31. Also in the second coil arrangement hole 32, similarly, the second coil 62 is held so as not to come out from the second coil arrangement hole 32.

The magnetic drive circuit 4 includes the first coil 61 and the second coil 62 as the coil 6. The first coil 61 is disposed in the first coil arrangement hole 31. The second coil 62 is disposed in the second coil arrangement hole 32. The coil 6 is an air-core coil in an elongated circular shape which is provided with two effective sides 601 extended in the third direction “Y”. A center of the coil 6 is provided with a center hole 602 which is extended in the third direction “Y”.

A magnet 7 faces the effective sides 601 of the coil 6 in the first direction “Z”. The magnet 7 includes two first magnets 71 and 72, which face the effective sides 601 of the first coil 61 and the second coil 62 from the Z1-direction side, and two second magnets 73 and 74 which face the effective sides 601 of the first coil 61 and the second coil 62 from the Z2-direction side. The first magnets 71 and 72 and the second magnets 73 and 74 are polarized and magnetized in the third direction “Y”. In this embodiment, the first coil 61 and the second coil 62 are the same coils as each other. Further, all of the first magnets 71 and 72 and the second magnets 73 and 74 are the same magnets as each other.

In this embodiment, the magnet 7 is disposed on both sides in the first direction “Z” with respect to the coil 6. However, the magnetic drive circuit 4 may be structured so that the magnet 7 is disposed with respect to the coil 6 on only one side in the Z1-direction and the Z2-direction. Further, in this embodiment, the magnetic drive circuit 4 structured of the coil 6 and the magnet 7 facing each other in the first direction “Z” is provided with two pairs. However, the present invention may be applied to an actuator which has the magnetic drive circuit 4 of one pair, or three or more pairs.

The movable body 3 includes a yoke 80 which holds the magnet 7. As shown in FIGS. 2, 3 and 4, the yoke 80 is provided with a first plate part 81 facing the plate part 33 of the coil holder 30 from the Z1-direction side, a second plate part 82 facing the plate part 33 from the Z2-direction side, and a pair of connecting plate parts 83 and 84 which are extended in the first direction “Z” on both sides in the second direction “X” with respect to the plate part 33 to connect the first plate part 81 with the second plate part 82. A surface in the Z2-direction of the first plate part 81 is fixed with the first magnets 71 and 72 side by side in the second direction “X”. A surface in the Z1-direction of the second plate part 82 is fixed with the second magnets 73 and 74 side by side in the second direction “X”. The first magnets 71 and 72 and the second magnets 73 and 74 are fixed to the yoke 80 by a method such as adhesion.

The yoke 80 is manufactured by joining two parts, i.e., a first yoke 85 provided with the first plate part 81 and a pair of the connecting plate parts 83 and 84 which are bent to the Z2-direction from both ends in the second direction “X” of the first plate part 81, and a second yoke 86 which is the second plate part 82. The connecting plate part 83 is extended to the Z2-direction through the cut-out part 301 of the coil holder 30 on the X1-direction side with respect to the first coil 61, and the connecting plate part 84 is extended to the Z2-direction through the opening part 302 of the coil holder 30 on the X2-direction side with respect to the second coil 62. End parts in the Z2-direction of a pair of the connecting plate parts 83 and 84 are connected with both end parts in the second direction “X” of the second plate part 82 by welding.

### Connection Body

As shown in FIG. 2, the connection body 9 is disposed in a portion where the support body 2 and the movable body 3 face each other in the first direction “Z”. The movable body 3 is supported movably in the second direction “X” by the connection body 9. In this embodiment, the connection body 9 includes first connection bodies 91 and 92, which are disposed in a portion where the first yoke 85 and the first case member 10 face each other in the first direction “Z”, and second connection bodies 93 and 94 which are disposed in a portion where the second yoke 86 and the second case member 20 face each other in the first direction “Z”.

The first connection bodies 91 and 92 are disposed between the first plate part 81 of the first yoke 85 and bottom faces of the recessed parts 13 of the first case member 10 in a compressed state in the first direction “Z”. In this embodiment, two first connection bodies 91 and 92 are disposed in parallel in the second direction “X”. Further, the second connection bodies 93 and 94 are disposed between the second plate part 82 of the second yoke 86 and bottom faces of the recessed parts 23 of the second case member 20 in a compressed state in the first direction “Z”. In this embodiment, two second connection bodies 93 and 94 are disposed in parallel in the second direction “X”.

In this embodiment, the connection body 9 is a viscoelastic body. For example, the connection body 9 (viscoelastic body) is silicone gel whose penetration degree is from 10 to 110 degrees. The penetration degree is prescribed in JIS-K-2207 and JIS-K-2220, and the smaller the value is, the hardness is larger. In this embodiment, the viscoelastic characteristics of the silicone gel is not limited to the above-mentioned gel. For example, as described below, silicone gel whose viscous component is large and attenuation coefficient is high may be used. Further, as the connection body 9 provided with viscoelasticity, various rubber materials such as natural rubber, diene-based rubber (for example, styrene butadiene rubber, isoprene rubber, butadiene rubber, chloroprene rubber and acrylonitrile butadiene rubber), non diene-based rubber (for example, butyl rubber, ethylene propylene rubber, ethylene propylene diene rubber, urethane rubber, silicone rubber and fluorine rubber) and thermoplastic elastomer, and their denatured materials may be used.

The connection body 9 is provided with linear or non-linear expansion and contraction characteristics according to its expansion and contraction direction. For example, the connection body 9 is provided with expansion and contraction characteristics whose non-linear component (viscous component) is larger than a linear component (spring component) when it is pressed in its thickness direction (axial direction) to be compressed and deformed. On the other hand, the connection body 9 is provided with expansion and contraction characteristics whose linear component (spring component) is larger than a non-linear component (viscous component) when it is pulled and extended in its thickness direction (axial direction). Further, in a case that the connection body 9 is deformed in a direction intersecting its thickness direction (axial direction), i.e., in its shearing direction, even when it is moved in either direction, the connection body 9 is deformed in a direction where the connection body 9 is pulled and extended. Therefore, the connection body 9 is provided with deformation characteristics whose linear component (spring component) is larger than a non-linear component (viscous component).

When the movable body 3 is vibrated in the second direction “X”, the connection body 9 is deformed in a shearing direction. Therefore, the connection body 9 uses deformation characteristics in the shear direction when the movable body 3 is vibrated in the second direction “X” and thus, reproducibility of vibration acceleration to an input signal can be improved and vibration with a delicate nuance can be realized.

### Selection of Viscoelastic Body and Voltage Characteristics Used in Drive Control

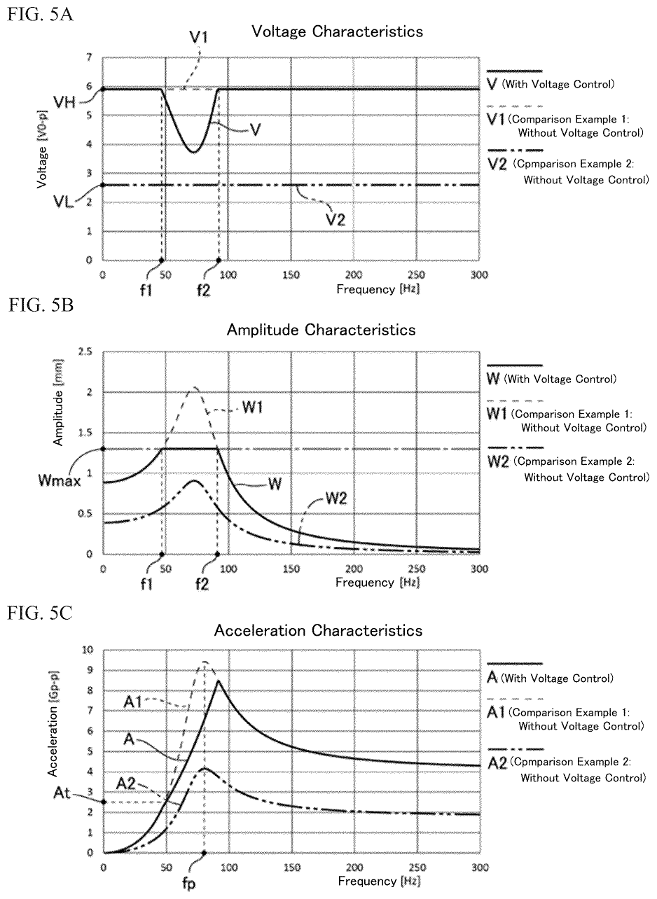

FIGS. 5A to 5C are explanatory views showing voltage characteristics, amplitude characteristics and acceleration characteristics of the actuator 1. FIG. 5A is a graph showing voltage characteristics, FIG. 5B is a graph showing amplitude characteristics, and FIG. 5C is a graph showing acceleration characteristics. In FIGS. 5A through 5C, the voltage characteristic “V”, amplitude characteristic “W” and acceleration characteristic “A” shown by the solid lines show characteristics of the actuator 1 in this embodiment. The voltage characteristic “V1”, amplitude characteristic “W1” and acceleration characteristic “A1” shown by the broken lines show characteristics of a comparison example 1. The voltage characteristic “V2”, amplitude characteristic “W2” and acceleration characteristic “A2” shown by the two dot chain lines show characteristics of a comparison example 2.

The amplitude characteristics “W”, “W1” and “W2” shown in FIG. 5B and the acceleration characteristics “A”, “A1” and “A2” shown in FIG. 5C can be obtained as a solution of a motion equation of one freedom degree vibration system based on weight of the movable body 3, viscoelastic characteristics (spring element+damping element) of the connection body 9, and a Lorentz force of the magnetic drive circuit (in other words, thrust which vibrates the movable body 3). Therefore, a specific structure of the actuator 1 is determined, amplitude characteristics “W”, “W1” and “W0” and acceleration characteristics “A”, “A1” and “A2” can be obtained from a motion equation with voltage characteristics “V”, “V” and “V2” as parameters. Alternatively, amplitude characteristics “W”, “W1” and “W2” and acceleration characteristics “A”, “A” and “A2” may be obtained through measurement by driving a prototype movable body 3 with voltage characteristics “V”, “V1” and “V2”.

In this embodiment, by focusing on a viscoelastic characteristic (spring element +damping element) of the connection body 9 which is one of parameters defining acceleration characteristics “A”, “A1” and “A2”, a type of viscoelastic body used for the connection body 9 is selected so as to attain acceleration not less than a target acceleration “At” (for example, At=2.5 Gal) in a target frequency band (for example, 50 Hz or more and 100 Hz or less) which is demanded by a user of the actuator. In this case, viscoelastic body is selected by focusing on that, when a viscoelastic body whose damping coefficient is high is used, a level of acceleration is, as a whole, shifted to a high level in a wide frequency band.

The characteristic of the comparison example 1 is a characteristic in a case that, in a structure of the actuator 1 in which viscoelastic body selected so as to satisfy the above-mentioned condition is used, the actuator 1 is driven at a first voltage “VH” (VH=5.9V) in an entire frequency band. In other words, the voltage characteristic of the comparison example 1 is set to be “without voltage control” in the entire frequency band. As shown in FIG. 5C, in a case that voltage of a drive current is set to be a constant value, a frequency that acceleration of the movable body 3 becomes the maximum acceleration is referred to as a peak frequency “fp”. As shown in FIG. 5B, amplitude of the movable body 3 becomes the maximum amplitude at the peak frequency “fp” or the vicinity thereof.

As understood from the amplitude characteristic “W1” of the comparison example 1, when driven at the first voltage “VH” in the entire frequency band, the amplitude of the movable body 3 exceeds the upper limit amplitude “Wmax” of the actuator 1 in this embodiment in an intermediate frequency band from a first frequency “f1” to a second frequency “f2”. The upper limit amplitude “Wmax” is the maximum amplitude that the movable body 3 is capable of vibrating without colliding with the support body 2 in the actuator 1 in this embodiment. The maximum amplitude is determined by the smallest gap space in a portion where the movable body 3 and the support body 2 face each other in the second direction “X”. For example, in this embodiment, the upper limit amplitude “Wmax” is set as “Wmax”=1.3 mm. In this embodiment, the upper limit amplitude “Wmax” is not required to be the same as the maximum amplitude and may be set to a value smaller than the maximum amplitude in consideration of disorder of amplitude due to disturbance and the like.

In this embodiment, in the intermediate frequency band from the first frequency “f1” to the second frequency “f2”, the voltage characteristic “V” is set so that voltage of a drive current becomes a value lower than the first voltage “VH” (see FIG. 5A). In other words, in the voltage characteristic in this embodiment, the intermediate frequency band from the first frequency “f1” to the second frequency “f2” is defined as a voltage control section, and the voltage control section is set as “with voltage control”, and other sections are set as “without voltage control” (in other words, the voltage is set at a constant value). In this manner, in the intermediate frequency band from the first frequency “f1” to the second frequency “f2”, the amplitude of the movable body 3 is prevented from exceeding the upper limit amplitude “Wmax”.

More specifically, in a frequency band from the first frequency “f1” to a peak frequency, a characteristic is adopted in which voltage is reduced as a frequency becomes higher. On the other hand, in a frequency band from the peak frequency to the second frequency “f2”, a characteristic is adopted in which the voltage is increased as the frequency becomes higher. A shape of a curve of the voltage characteristic is set so that amplitude of the movable body 3 is matched with the upper limit amplitude “Wmax” in all frequencies of the intermediate frequency band from the first frequency “f1” to the second frequency “f2”.

As a result, in the acceleration characteristic “A” in the intermediate frequency band from the first frequency “f1” to the second frequency “f2”, in comparison with the acceleration characteristic “A1” of the comparison example 1 where the voltage is not controlled to be reduced, a rise in acceleration along with an increase of the frequency becomes gradual in a range from the first frequency “f1” to the second frequency “f2”, and the peak value of the acceleration is decreased. Further, the frequency that the peak value of the acceleration is obtained is a frequency that is higher than the peak frequency “fp”. Although different from the comparison example 1 as described above, the acceleration characteristic “A” obtained by the voltage characteristic “V” in this embodiment satisfies a condition that acceleration not less than the target acceleration “At” (2.5 Gal) is obtained in the target frequency band (50 Hz or more and 100 Hz or less).

In the voltage characteristic “V2” of a comparison example 2, a second voltage “VL” (e.g., 2.6V) with which the amplitude at the peak frequency “fp” does not exceed the upper limit amplitude “Wmax” is determined, and the second voltage “VL” is used for driving in the entire frequency band. In other words, the voltage characteristic of the comparison example 2 is set to be “without voltage control” (however, low voltage) in the entire frequency band. However, in this case, although a necessary condition that an amplitude characteristic “W0” does not exceed the upper limit amplitude “Wmax” is satisfied, the acceleration characteristic “A2” is unable to satisfy the target acceleration (2.5 Gal) in a part of the target frequency band (50 Hz or more and 100 Hz or less).

### Principal Effects in This Embodiment

As described above, the actuator 1 in this embodiment includes the support body 2 and the movable body 3, the connection body 9 connected with the movable body 3 and the support body 2, the magnetic drive circuit 4 which vibrates the movable body 3 with respect to the support body 2, and the control part 1A which controls a drive current supplied to the magnetic drive circuit 4. The connection body 9 is a viscoelastic body. The maximum amplitude of the movable body 3 which does not collide with the support body 2 is defined as the upper limit amplitude “Wmax”, a frequency at which acceleration or amplitude of the movable body 3 becomes the maximum in a case that the voltage of the drive current is kept in a constant value, is defined as a peak frequency “fp”, in a target frequency band including the peak frequency “fp”, a voltage with which acceleration of the movable body 3 becomes a target acceleration “At” determined in advance or more, and the voltage with which the amplitude of the movable body 3 exceeds the upper limit amplitude “Wmax” in the peak frequency “fp” is defined as a first voltage “VH”, when the voltage of the drive current is set at the first voltage “VH”, in a case that a frequency band where the amplitude of the movable body 3 becomes the upper limit amplitude “Wmax” or more is an intermediate frequency band which is from a first frequency “f1” lower than the peak frequency “fp” to a second frequency “f2” higher than the peak frequency “fp”, the control part 1A sets the voltage of the drive current to be the first voltage “VH” when the control part drives in a low frequency band which is lower than the first frequency “f1” and in a high frequency band which is higher than the second frequency “f2” and, when the control part drives in the intermediate frequency band, the voltage of the drive current is set to be lower than the first voltage “VH” and so that the amplitude of the movable body 3 becomes not more than the upper limit amplitude “Wmax”.

According to this embodiment, in addition to a frequency near the peak frequency “fp”, the acceleration of the movable body 3 can be increased in a further wide range of frequencies. In other words, a voltage with which a target acceleration “At” is obtained in a target frequency band is set as a first voltage “VH” and an electric current at the first voltage “VH” is supplied to obtain a large acceleration unless the amplitude of the movable body 3 exceeds the upper limit amplitude “Wmax”. On the other hand, in a frequency band in which the amplitude of the movable body 3 exceeds the upper limit amplitude “Wmax” when driven at the first voltage “VH”, a voltage of the drive current is set to be lower than the first voltage “VH” to avoid a collision between the movable body 3 and the support body 2. As a result, an actuator 1 can be provided in which the target acceleration “At” can be obtained in the target frequency band, and a collision between the movable body 3 and the support body 2 can be avoided.

In this embodiment, when driven at a frequency in an intermediate frequency band (in other words, a frequency band in which the amplitude of the movable body 3 exceeds the upper limit amplitude “Wmax” when an electric current at the first voltage “VH” is supplied), the control part 1A performs control that the voltage of the drive current is reduced to a voltage at which the amplitude of the movable body 3 matches the upper limit amplitude “Wmax”. According to this structure, the acceleration of the movable body 3 can be increased to the maximum. Therefore, vibration that a user senses bodily can be increased.

In this embodiment, the peak frequency “fp” uses an acceleration peak frequency at which acceleration of the movable body 3 becomes the maximum when the voltage of the drive current is set to be a constant value. In this case, an amplitude peak frequency at which the amplitude of the movable body 3 becomes the maximum may be obtained from an amplitude characteristic of the movable body 3 when the voltage of the drive current is set to be a constant value, and the amplitude peak frequency is used as the peak frequency “fp”.

In this embodiment, the target frequency band is set to be 50 Hz or more and 100 Hz or less. When the voltage control is performed as described in this embodiment, the target acceleration “At” (e.g., At=2.5 Gal) can be obtained in a wide range of, for example, 50 Hz or more and 100 Hz or less in addition to frequencies near the peak frequency “fp”.

In this embodiment, when the control part 1A drives at a frequency in a range from the first frequency “f1” to the peak frequency “fp”, the voltage of the drive current is decreased as the frequency becomes higher and, when the control part 1A drives at the peak frequency “fp”, the voltage of the drive current is set at a voltage that the amplitude of the movable body 3 matches the upper limit amplitude “Wmax” and, when the control part 1A drives at a frequency in a range from the peak frequency “fp” to the second frequency “f2”, the voltage of the drive current is increased as the frequency becomes higher. As described above, when a voltage pattern in which voltage becomes lowest in the peak frequency “fp” is used, acceleration of the movable body 3 is capable of exceeding a target value in a wide range. Further, the amplitude of the movable body 3 can be matched with the upper limit amplitude “Wmax” in a wide frequency band, and acceleration of the movable body 3 can be increased in a wide frequency band.

In this embodiment, the magnetic drive circuit 4 includes the coil 6 and the magnet 7 facing the coil 6 in the first direction “Z” and vibrates the movable body 3 in the second direction “X” intersecting the first direction “Z” with respect to the support body 2. The viscoelastic body is disposed in a portion where the support body 2 and the movable body 3 face each other in the first direction “Z” with the first direction “Z” as its thickness direction and, when the movable body 3 is moved in the second direction “X” with respect to the support body 2, the viscoelastic body is deformed in its shear direction. According to this structure, acceleration of the movable body 3 can be increased in a wide frequency band by adjusting characteristics of the viscoelastic body. Therefore, the amplitude of the movable body 3 is prevented from becoming too large by adjusting voltage of the drive current and thus, a collision between the movable body 3 and the support body 2 can be avoided.

In this embodiment, silicone gel may be used as a viscoelastic body. The silicone gel is capable of adjusting viscoelastic characteristics (spring element+damping element) by adjusting blending ratio of materials. Therefore, a viscoelastic body having a high damping coefficient can be selected.

What is claimed is:

1. An actuator comprising:
a support body and a movable body;
a connection body which is connected with the movable body and the support body;
a magnetic drive circuit which vibrates the movable body with respect to the support body; and
a control part which controls a drive current supplied to the magnetic drive circuit;
wherein the connection body is a viscoelastic body;
a maximum amplitude of the movable body which does not collide with the support body is defined as an upper limit amplitude;
a frequency at which acceleration or amplitude of the movable body becomes a maximum in a case that voltage of the drive current is kept in a constant value is defined as a peak frequency;
in a target frequency band including the peak frequency, a voltage with which acceleration of the movable body becomes a target acceleration determined in advance or more, and the voltage with which the amplitude of the movable body exceeds the upper limit amplitude at the peak frequency is defined as a first voltage,
when the voltage of the drive current is set to be the first voltage, in a case that a frequency band where the amplitude of the movable body becomes the upper limit amplitude or more is an intermediate frequency band which is from a first frequency lower than the peak frequency to a second frequency higher than the peak frequency,
the control part sets the voltage of the drive current to be the first voltage when the control part drives in a low frequency band which is lower than the first frequency and in a high frequency band which is higher than the second frequency, and
when the control part drives in the intermediate frequency band, the voltage of the drive current is set to be lower than the first voltage and the amplitude of the movable body becomes not more than the upper limit amplitude.

2. The actuator according to claim 1, wherein when the control part drives at a frequency in the intermediate frequency band, the control part sets the voltage of the drive current to a voltage at which the amplitude of the movable body matches the upper limit amplitude.

3. The actuator according to claim 1, wherein the target frequency band is 50 Hz or more and 100 Hz or less.

4. The actuator according to claim 1, wherein the peak frequency is an acceleration peak frequency at which the acceleration of the movable body becomes maximum when the voltage of the drive current is set at a constant value.

5. The actuator according to claim 1, wherein
when the control part drives at a frequency in a low frequency range, the voltage of the drive current is decreased as the frequency becomes higher,
when the control part drives at the peak frequency, the voltage of the drive current is set at a voltage at which the amplitude of the movable body matches the upper limit amplitude, and
when the control part drives in a high frequency range, the voltage of the drive current is increased as the frequency becomes higher.

6. The actuator according to claim 1, wherein
the magnetic drive circuit comprises a coil and a magnet facing the coil in a first direction and vibrates the movable body in a second direction intersecting the first direction with respect to the support body,
the viscoelastic body is disposed in a portion where the support body and the movable body face each other in the first direction with the first direction as a thickness direction, and
when the movable body is moved in the second direction with respect to the support body, the viscoelastic body is deformed in a shear direction.

7. The actuator according to claim 1, wherein the viscoelastic body is silicone gel.
